(19) United States
(12) Patent Application Publication
(10) Pub. No.: US 2009/0003633 A1
(43) Pub. Date: Jan. 1, 2009

(54) Filter Element

(75) Inventors: Valerie Thoraval, Morance (FR); Didier Dhaler, Tassin La Demie-Lune (FR)

Correspondence Address: MARSH, FISCHMANN & BREYFOGLE LLP, 8055 East Tufts Avenue, Suite 450, Denver, CO, 80237, US

(73) Assignee: APPLEXTON, SAINT MAURICE DE BEYOST (FR)

(21) Appl. No.: 12/160,912

(22) PCT Filed: Jan. 4, 2007
(86) PCT No.: PCT/US07/00089

§ 371 Date: Jul. 15, 2008

Related U.S. Application Data
(60) Provisional application No. 60/756,158, filed on Jan. 4, 2006.

(51) Int. Cl. H04R 1/00

(52) U.S. Cl. 381/182

(57) ABSTRACT

The invention relates to a filter element comprising a support with an outside surface and at least three channels in the support. The channels comprise a peripheral wall directed towards the outside surface, the distance between the peripheral wall and the outside surface reducing on each side of the middle of the peripheral wall. The element has the advantage of improved strength when subject to severe conditions of use.

This invention relates to a filter element and a filter module.

Document FR-A-2 720 953 describes an inorganic filter element for a fluid medium, intended for separating out a filtrate. The element is of the type comprising an inorganic rigid porous support having an elongated shape. Inside the support, at least two channels are made parallel to the axis of the support, the surface of the channels being covered by at least one separating layer intended to be in contact with the fluid medium. Each channel is arranged such that a zone of its surface is placed directly facing a fraction of the outside surface of the support. This is in order to form a passage for conveying the filtrate coming only from said surface of the channel. Moreover, the zones of the surfaces of the channels, with the facing outside surfaces of the support, define support thicknesses which are approximately constant.

Document FR-A-2 720 954 describes an inorganic filter element for a fluid medium, intended for separating out a filtrate. The element is of the type comprising an inorganic rigid porous support of a cylindrical shape, having a longitudinal central axis. Channels are arranged in the support parallel to its central axis, the centres of which are situated in a circle coaxial to the central axis. Each channel has a surface covered by at least one separating layer intended to be in contact with the fluid medium. Each channel also comprises on the one hand, at least one peripheral wall directed towards the outside surface of the support and defining with the latter a passage having a constant thickness that conveys the filtrate; on the other hand, each channel comprises at least one radial wall, which together with the facing radial wall of an adjacent channel defines a partition. The walls are connected to one another via connection fillets. Moreover, each radial partition has a constant thickness over its entire height; the ratio of the height of a partition to its thickness is less than or equal to 8. The connection fillets have a radius comprised between 0.3 and 1.5 mm.

Document FR 2 741 821 describes an inorganic filter element for a fluid medium, intended for separating out a filtrate. The element is of the type comprising an inorganic rigid porous support of a cylindrical shape, having a longitudinal central axis. Channels are arranged in the support, parallel to its central axis, and have a surface covered by at least one separating layer intended to be in contact with the fluid medium. At least some of the channels termed peripheral have their centres situated in a circle coaxial to the central axis; these peripheral channels have, on the one hand, a peripheral wall facing the outside surface of the support and defining with the latter, a passage that conveys the filtrate directly and, on the other hand, at least one radial wall, which together with the facing radial wall of an adjacent channel defines a partition. The walls are connected to one another by connection fillets. The peripheral channels also each have a non-circular straight cross section. Moreover, the peripheral channels each have a conveying passage, the thickness of which increases on each side of the middle of the passage and in the opposite direction to the middle. Each conveying passage has an arch-shaped profile.

Moreover, the channels of the element in document FR-A-2 741 821 between them define partitions, the thickness of which increases in the direction of the central axis of the porous support.

Document EP-A-0 609 275 describes a ceramic element for cross current or tangential flow filtration of liquids and gases. The element has an elongated support body made of porous ceramic material with at least two coaxial channels extending through the support body. A monolayer or multilayer ceramic membrane with a calibrated porous structure is applied to the surface of the channels; the filtrate, filtered using the membrane from a fluid passing through the channels, leaves the support body by the side surface of these channels, where it is collected using a suitable device. The channels are arranged coaxially around the imaginary central axis of the support body. Seen in cross section, the channels have a wall facing outwards, the contour of which follows the outer contour of the support body; thus the support body here has a uniform wall thickness. The other walls of the channels have a contour such that the partitions in place between the channels increase in thickness towards the outside in a wedge shape; the thickness of the partitions increases up to a maximum of three times the smallest wall thickness.

There is therefore a need for an element which offers an alternative to the elements described previously.

To this end, the invention proposes a filter element comprising a support with an outside surface, at least three channels in the support, the channels comprising a peripheral wall directed towards the outside surface, the distance between the peripheral wall and the outside surface reducing on each side of the middle of the peripheral wall.

The invention relates to a filter element comprising a support with an outside surface, three channels in the support, the channels comprising a peripheral wall directed towards the outside surface, the distance between the peripheral wall and the outside surface reducing on each side of the middle of the peripheral wall; excluding the element comprising channels in a circle, these channels being heart-shaped and comprising moreover a side wall directed towards an adjacent channel, the side walls of two adjacent channels forming a partition having a constant thickness.

The invention relates to a filter element comprising a support with an outside surface, three channels in the support, the channels comprising a peripheral wall directed towards the outside surface, the distance between the peripheral wall and the outside surface reducing on each side of the middle of the peripheral wall; excluding the element comprising channels in a circle, these channels having shape comprising a cusp.

According to a variant, the channels comprise moreover a side wall directed towards an adjacent channel, the side walls of two adjacent channels forming a partition having a constant thickness.

According to a variant, the channels comprise moreover a side wall directed towards an adjacent channel, the side walls of two adjacent channels forming a partition of variable thickness.

According to a variant, the channels comprise moreover a side wall directed towards an adjacent channel, the side walls of two adjacent channels forming a partition, the partition having a thickness which increases from the centre of the support towards the outside surface.

According to a variant, the partition moreover has one part with a constant thickness.

According to a variant, the part of the partition the thickness of which is constant and the part of the partition flaring towards the outside surface are the same height.

According to a variant, the ratio of the height of the part having a constant thickness to the total height of the partition is between 1:4 and 3:4, preferably between 1:3 and 2:3.

According to a variant, in straight cross section, the side wall of the channels comprises at least two sections forming between them an angle of 1° to 45°, preferably 10° to 25°.

According to a variant, the peripheral wall and the side wall are connected by a connection fillet.

According to a variant, the element comprises two side walls, the side walls being connected by a connection fillet to the peripheral wall.

According to a variant, the side walls are connected by a connection fillet.

According to a variant, the connection fillet between the side walls has a diameter of 0.2 to 2 mm, preferably 0.3 to 1 mm.

According to a variant, the connection fillet between a side wall and the peripheral wall has a diameter of 1 to 4 mm, preferably 1.7 to 3 mm.

According to a variant, the element comprises between 5 and 10 channels, preferably between 6 and 9 channels.

According to a variant, the channels are in at least one circle.

According to a variant, the channels are in several concentric circles.

According to a variant, the channels comprise a side wall directed towards an adjacent channel of a single circle, the side walls of two adjacent channels forming a partition, and the side walls of two adjacent channels of a single circle forming a partition of variable thickness.

According to a variant, the partition between two channels of the centremost circle of the support has a thickness increasing towards the outside surface and the partition between two channels of the other circle(s) has a thickness reducing towards the outside surface.

According to a variant, the partition between two channels of the centremost circle of the support has a thickness increasing towards the outside surface and the partition between two channels of the other circle(s) has a thickness reducing and then increasing towards the outside surface.

According to a variant, the element comprises at least one ring of channels intermingled with the channels of another ring.

According to a variant, the distance between the peripheral wall of the channels and the outside surface of the support reduces on each side of the middle of the peripheral wall.

According to a variant, along a straight cross section, the element has a circular shape, the peripheral wall of the channels being flat.

According to a variant, the peripheral wall is concave.

According to a variant, the element does not comprise a separation layer.

According to a variant, the element comprises a separation layer on the inside surface of the channels.

The invention also relates to a filter module comprising several filter elements as previously defined.

Other characteristics and advantages of the invention will become apparent when reading the following detailed description of the embodiments of the invention, given as an example only and with reference to the drawings, which show:

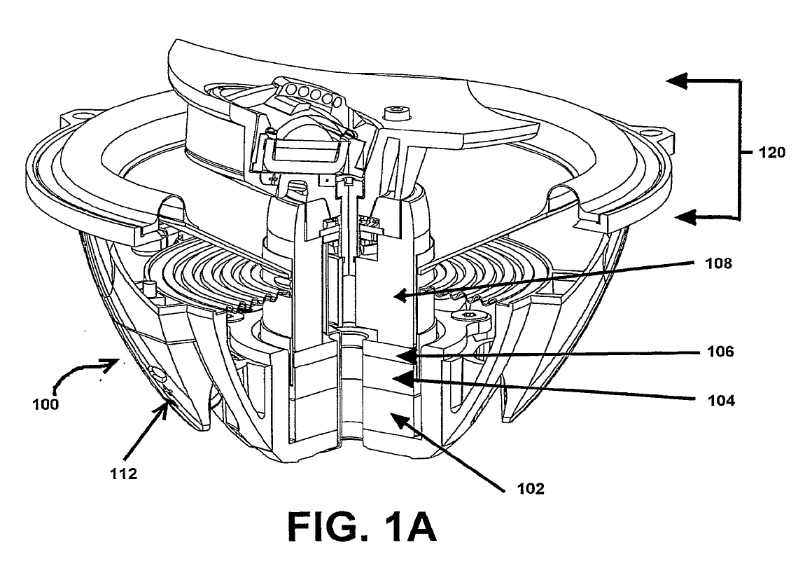

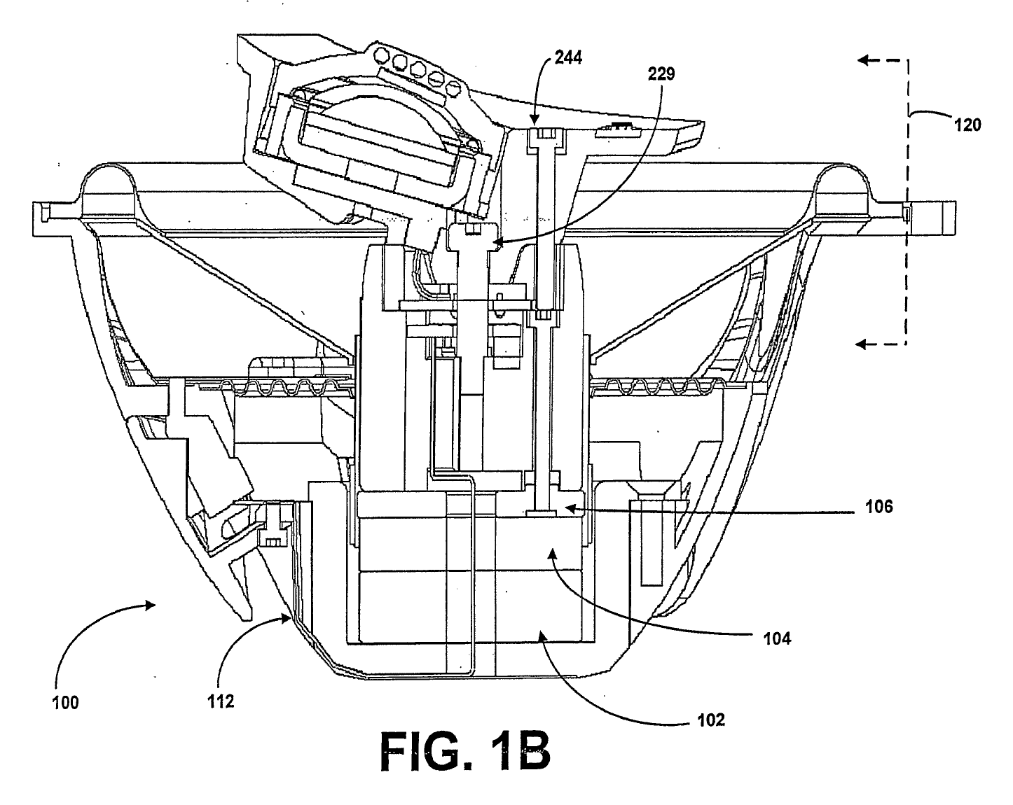

FIG. 1, a filter element according to one embodiment;

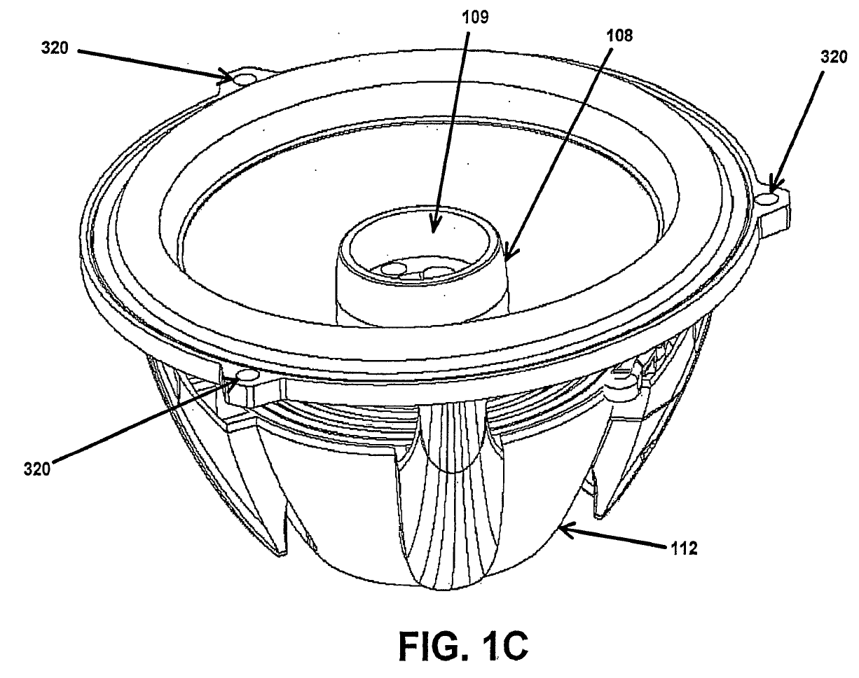

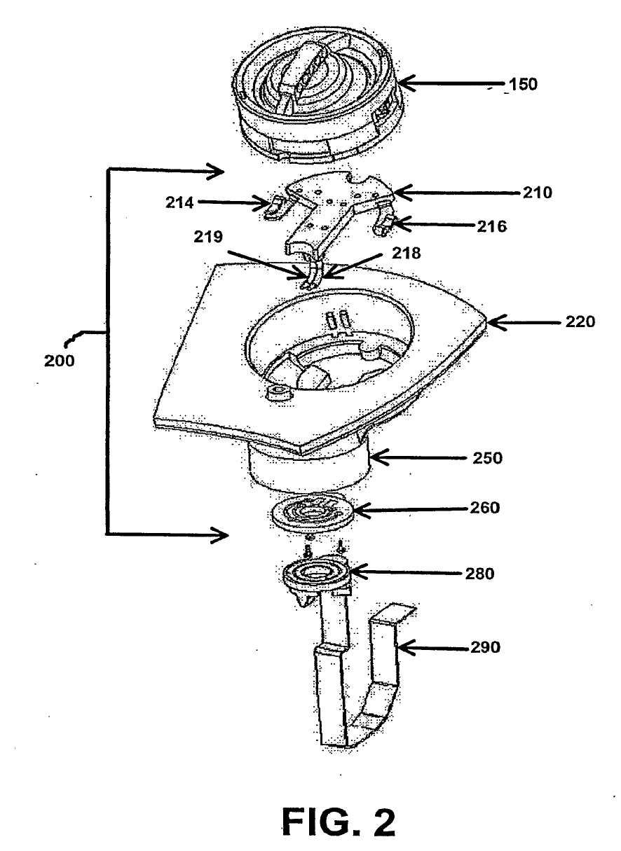

FIG. 2, a filter element according to another embodiment;

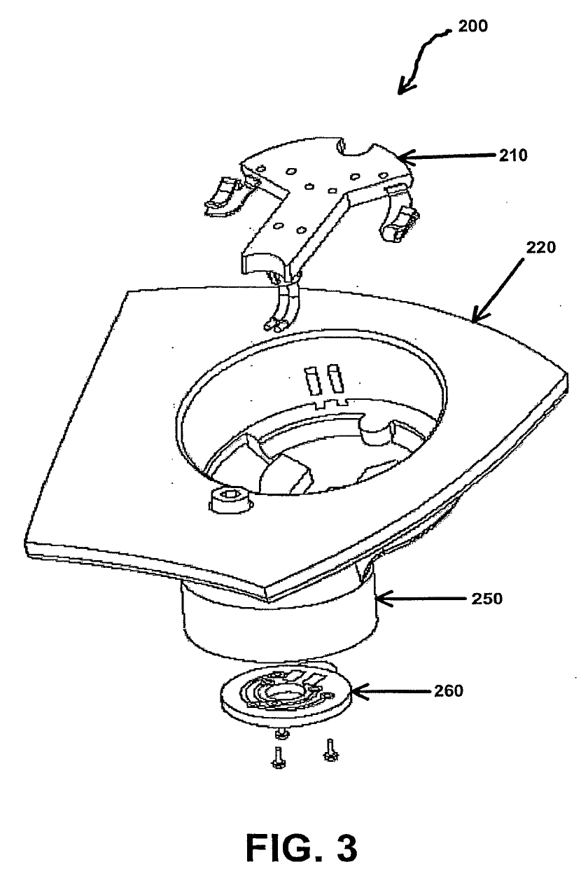

FIGS. 3 to 6, a filter element according to further embodiments;

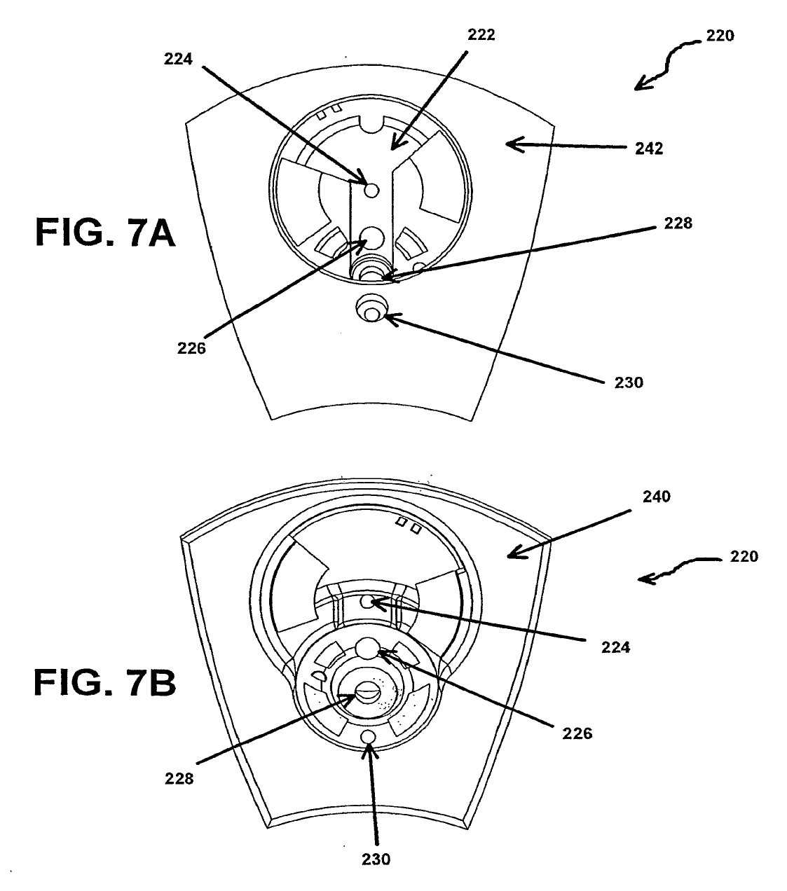

FIG. 7, a filter element according to an excluded embodiment of the invention;

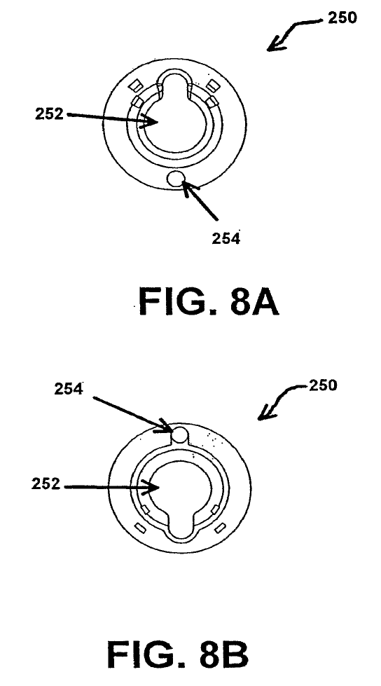

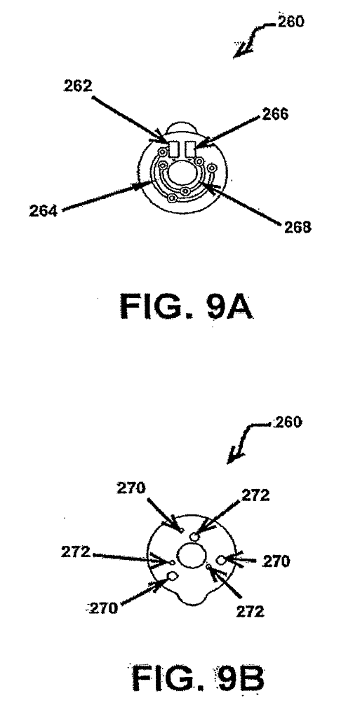

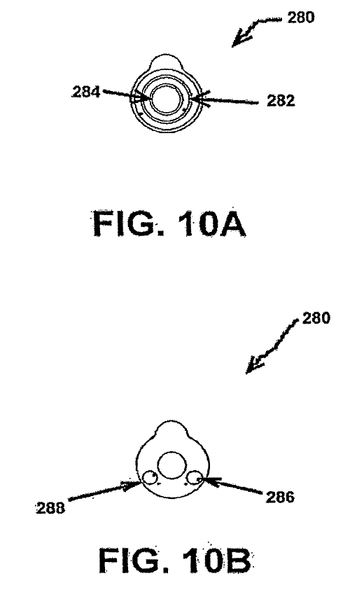

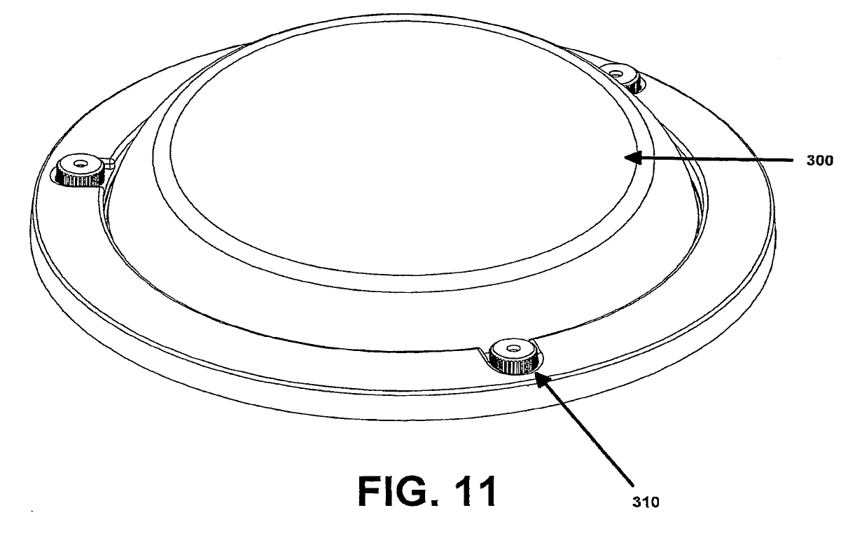

FIG. 8, a channel according to one embodiment.

The invention relates to a filter element comprising a support with an outside surface and at least three channels in the support. The channels comprise a peripheral wall directed towards the outside surface, the distance between the peripheral wall and the outside surface reducing on each side of the middle of the peripheral wall. The element has the advantage of improved strength when subject to severe conditions of use.

FIG. 1 shows an embodiment of a filter element 10. The element 10 allows for tangential filtration to be implemented. The element 10 comprises a support 12 with an outside surface 14. The support 12 can have a cylindrical tubular shape with a central axis 11. The cross section of the support 12 is constant in the direction of the axis 11; all the cross sections of the support, whatever their position along the axis 11, have the shape shown in FIG. 1. This shape can be circular, hexagonal or other. The support 12 is preferably monolithic. The support 12 is porous so as to allow the circulation of a fluid. The support 12 is for example made of ceramic material obtained by extrusion using a die.

The element 10 comprises in the support 12 at least three channels 161, 162, 163; in FIG. 1, the element 10 comprises six channels 161 to 166. The channels labelled 16 throughout, pass through the support 12 along its entire length in the direction of the axis 11. The channels 16 are obtained during extrusion of the support, the die giving a shape to the channels. After firing the ceramic material, the inside surface of the channels 16 can be covered, or not, with a thin layer of a substance making it possible to obtain by sintering a filtering layer or membrane 17 (or separation layer) on the inside surface of the channels.

For a filtering operation to be carried out in a filter element, the fluid medium to be filtered is circulated inside the channels 16 in the direction of the axis 11. A pressure difference is established between the inside part of the element 10 and the atmosphere outside the element. A fraction of the fluid medium to be filtered passes through the filter membranes of the channels to impregnate the porous material of the support 12. This fraction (or permeate) of the medium to be filtered circulates inside the support 12 in the direction of the outside surface 14 of the support 12.

The channels 16 comprise a peripheral wall 18 directed towards the outside surface 14. According to FIG. 1, the wall 18 can be facing the outside surface 14; the wall 18 can define a passage conveying the permeate directly towards the outside of the element. This has the advantage of facilitating the evacuation of the permeate from the channel towards the outside of the element. The distance between the peripheral wall 18 and the outside surface 14 becomes smaller on each side of the middle of the peripheral wall. According to the position of the channels in FIG. 1, the passage for conveying the permeate is thicker in the middle of the peripheral wall 18 than at the ends of the peripheral wall 18. This makes it possible to obtain a greater thickness of the support 12 between the channel 16 and the wall 18, at the middle of the peripheral wall. As the pressure of the fluid to be filtered is higher at the centre of the peripheral wall, the strength of the element 10 is thus increased.

Preferably, the distance “d” between the middle of the wall 18 and the outside surface 14 continually reduces on each side of the middle of the peripheral wall 18. This makes it possible to obtain a continuous inside surface of the channel, promoting contact between the fluid to be filtered and the support. In FIG. 1, the distance between the middle of the wall 18 and the outside surface is increased by the peripheral wall 18 which protrudes towards the inside of the channel; the wall 18 can be a concave curve, the support 12 penetrating towards the inside of the channels 16. This has the advantage of increasing the inside surface of the channel in contact with the fluid and thus increasing the surface area and the filtration capacity of the element 10. Alternatively, according to FIG. 2, the wall 18 can be flat and the support can have a circular cross section; the distance between the flat wall 18 and the circular outside surface therefore becomes smaller on each side of the middle of the wall 18. The embodiment in FIG. 2 only differs from the one in FIG. 1 by the shape of the wall 18.

The channels 16 also comprise a side wall 20. The side wall 20 of a channel 161 is directed towards an adjacent channel 162. The shape of the channels is variable; as an example, according to FIG. 1, the channels 16 have two side walls 20, each connected to the peripheral wall. The side walls 20 are connected to the peripheral wall 18 using a connection fillet 24. The connection fillet makes it possible to improve the deposition of the filter layer 17 on the inside surface of the channels, as appropriate. The deposition of the filter layer 17 is more uniform. Moreover, using the connection fillets, the stresses on the support from the fluid to be filtered are better distributed along the surface of the channel. Moreover, the side walls 20 can also be connected to each other, preferably by a connection fillet 26. The advantages associated with the fillet 26 are the same as the advantages associated with the fillet 24.

According to FIGS. 1 and 2, the channels 16 have a globally triangular shape; the side walls 20 are connected at one of their ends by the fillet 26 and at their other end are connected to the wall 18 by the fillet 24. As the wall 18 can be a concave curve (FIG. 1), the curve is connected to the fillets 24. In the following, “wall” denotes the zone of the channel comprised between two connection fillets, without taking account of the fillets. Thus, the side walls 20 are between the fillet 26 and a fillet 24 and the peripheral wall 18 is between two fillets 24.

The side wall 20 of two adjacent channels 161 and 162 forms a partition 22. The partition 22 is a zone of the support 12 allowing the circulation of the fluid between the channels 16 in the direction of the outside surface of the support. The partition 22 makes it possible for the fluid to be filtered through the side walls of the channels then circulated in the direction of the outside surface of the support. The partition 22 has a variable thickness. For example, the partition 22 opens out towards the outside surface. The thickness of the partition 22 increases from the centre of the support towards the outside surface of the support; in other words, the thickness of the partition 22 is greater close to the outside surface of the support than close to the central axis 11. The partition is thus wedge-shaped, making it possible to evacuate a larger quantity of permeate than in a partition having a constant thickness.

To form a partition flaring outwards, it can be envisaged that the partition between two channels flares continually over its entire height. A wedge-shaped partition is then obtained over the entire height of the partition.

Also, the partition 22 can flare outwards over at least a part of its height. The partition 22 has one part with a constant thickness “e1” and one part with a variable thickness “e2”. The thickness is variable in that the thickness “e2” increases in the direction of the outside surface 14 of the support 10. Thus an irregular partition is obtained.

To form an irregular-shaped partition, the side wall of the channels has a particular shape. In a cross section according to FIG. 1, the side wall 20 of the channels is a broken line. The side wall 20 comprises at least two rectilinear sections 201 and 202, between them forming an angle alpha α. The angle alpha α is for example 1° to 45°, preferably 10° to 25°. The sections 201 and 202 are connected by a connection fillet having a diameter greater than 0.3 mm, preferably greater than 0.4 mm, for example 1.5 to 2 mm. For each channel, the sections 201 are connected to each other by the fillet 26. The sections 201 of each channel between them form an angle. The sections 202 of each channel also between them form an angle. The angle between the sections 202 is narrower than the angle between the sections 201. The sections 201 give the channels a pointed shape which makes it possible to arrange the channels close to the centre of the support. The sections 201, on the one hand, and 202, on the other hand, flare in the direction of the peripheral wall 18. The sections 201, on the one hand, and 202, on the other hand, flare in the direction of the outside surface 14 of the support. But the sections 202 are flared less than the sections 201. The sections 202 could also be parallel. The channels have a molar shape. The higher the number of channels desired, the less the sections 201 are flared, and vice-versa.

The sections 201 and 202 can be of variable length. The sections 201 can be longer than the sections 202. For example, depending on the height of a channel (from the fillet 26 to the peripheral wall 18), the ratio between the height of the sections 201 and the height of the channel is between 1:4 and 3:4, preferably between 1:3 and 2:3. Thus, the ratio of the height at constant thickness of the partition 22 to the total height of the partition 22 is between 1:4 and 3:4, preferably between 1:3 and 2:3.

The sections 201 can also have the same length as the sections 202. Thus, of the height of a channel (from the fillet 26 to the peripheral wall 18), the sections 201 correspond to half the height and the sections 202 correspond to the other half of the height. Thus, the partition 22, defined between two side walls 20 of two adjacent channels 161, 162, has one part with a constant thickness which is the same height as the part of the partition having a variable thickness.

According to FIGS. 1 and 2, the part of the partition having a constant thickness is closer to the centre of the support 12 than the part of the partition having a variable thickness. In other words, from the axis 11 at the centre of the support to the outside surface 14 of the support 11, the partition 22 firstly has a constant thickness then a thickness increasing in the direction of the outside surface. This makes it possible to increase the fluid circulation flow in the support; the quantity of fluid in the support increases gradually as the outside surface becomes nearer, and is evacuated towards the outside of the support. Thus, more space is available in the support for circulation of the fluid, as the outside surface of the support becomes nearer. The flow of fluid to be filtered can therefore be increased.

The channels 16 can be arranged in the support in a circle centred on the central axis 11, in particular, in such a way that the channels have their centre situated in a circle centred on the central axis 11. The channels 16 are arranged in the support around a ring centred on the axis. This makes it possible to arrange the channels regularly in the support, which facilitates manufacture of the element. This arrangement is visible in FIG. 1. According to FIG. 1, the channels are arranged in identical fashion on the circle; this allows to the channels to function in identical fashion and to avoid preferential clogging of certain channels.

According to FIGS. 1 and 2, the channels 16 arranged in a circle have the fillet 26 connecting the side walls 20 close to the central axis 11 and the peripheral wall 18 facing the outside surface 14. The channels have their side walls directed towards the side wall of the adjacent channels. The side walls of two adjacent channels define the partition 22. Between the channels, one part of the partition 22 comprises a constant thickness “e1” and one part of the partition 22 comprises a variable thickness “e2”. The part having a constant thickness is closer to the centre than the part having a variable thickness. The variable thickness increases in the direction of the outside surface 14. The distance between the peripheral walls 18 and the facing outside surface reduces on each side of the middle of the peripheral wall. There is therefore on the one hand, a passage for the fluid to pass between the peripheral wall 18 and the outside surface 14 which is wider at the middle of the peripheral wall 18 to increase the strength of the support and on the other hand, partitions 22 between the channels, the thickness of which is constant, then becoming variable as the outside surface of the support becomes closer, to increase the fluid flow in the support. These characteristics make it possible for the element to withstand higher pressures used to increase the fluid flow circulating in the support.

As an example, the element 10 can have an outside diameter between 20 and 40 mm, preferably 25 mm. The connection fillets 24 can have a diameter of 1 to 4 mm, preferably 1.7 to 3 mm. The connection fillet 26 can have a diameter of 0.2 to 2 mm, preferably 0.3 to 1 mm. The number of channels 16 can be 5 to 10, preferably 6 to 9. The distance between the peripheral wall 18 of the channels and the outside surface 14, for an outside diameter of 25 mm, is for example 1.5 mm for the smallest distance to 3 mm for the largest distance in the middle of the peripheral wall; preferably the distance is 1.8 mm to 2.8 mm.

FIG. 3 shows another embodiment of the filter element 10. According to FIG. 3, the channels are arranged around two concentric circles 30, 32 centred on the axis 11. Of course, it is possible to increase further the number of circles in which the channels are arranged. The arrangement in FIG. 3 makes it possible to increase the surface area of the channels allowing filtration of the fluid.

According to FIG. 3, the channels comprise a side wall 20 directed towards an adjacent channel of a single circle, the side walls of two adjacent channels forming a partition. The side walls of two adjacent channels of a single circle form a partition 22 of variable thickness. Around the circle 30, the channels 16 define a partition 22 having a thickness increasing from the centre of the support towards the outside surface. The circle 30 is closer to the centre of the support than the circle 32. Around the circle 32, the channels 16 define a partition 22 having a thickness reducing from the centre of the support towards the outside surface. In a straight cross section, the channels 16 in FIG. 3 have the same shape as the channels in FIG. 1. Thus in FIG. 3 the sections 201 and 202 as well as the connection fillet 26 are shown. Around the circle 30, the thickness “e1” is constant then the thickness “e2” increases, flaring towards the outside surface; the partition 22 between two channels of the centremost circle 30 of the support has a thickness increasing towards the outside surface. The circle 30 corresponds to the arrangement of the channels according to FIG. 1. Around the circle 32, the thickness “e1” reduces towards the outside surface and the thickness “e2” depends on the alpha angle between the sections 201 and 202; the thickness “e2” can be constant or can increase in the direction of the outside surface. The thicknesses are therefore variable, promoting the circulation of the fluid towards the outside of the support. The support can comprise more than two concentric circles, the additional circles have an arrangement of channels according to that of circle 32.

According to FIG. 3, and whatever the circle, the distance between the peripheral wall 18 of the channels 16 and the outside surface 14 of the support reduces on each side of the middle of the peripheral wall. In particular, the peripheral wall 18 is concave; the wall 18 is domed towards the inside of the channel. The same remarks and descriptions as for FIG. 1 on the distance between the peripheral wall of the channels and the outside surface of the support and on the shape of the channels are applicable to FIG. 3.

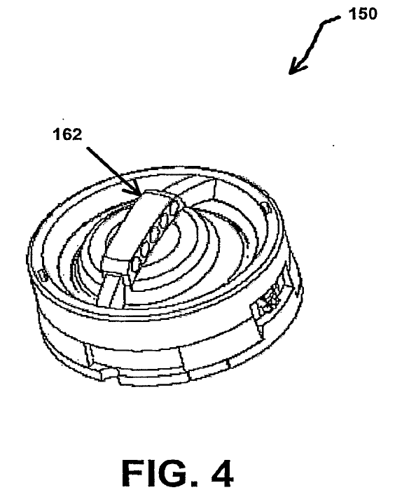

FIG. 4 shows a variant of the embodiment of the element in FIG. 3. In addition to FIG. 3, the element 10 in FIG. 4 comprises at least one ring of the channels intermingled with the channels of another ring. In fact, the channels 16 of the ring 32 are intermingled with the channels 16 of the ring 30. In particular, the connection fillets 26 of the channels of the ring 32 are arranged between the connection fillets 24 of two adjacent channels of the ring 30. This allows for space to be saved in the support, making it possible to increase the filtering surface area of the channels.

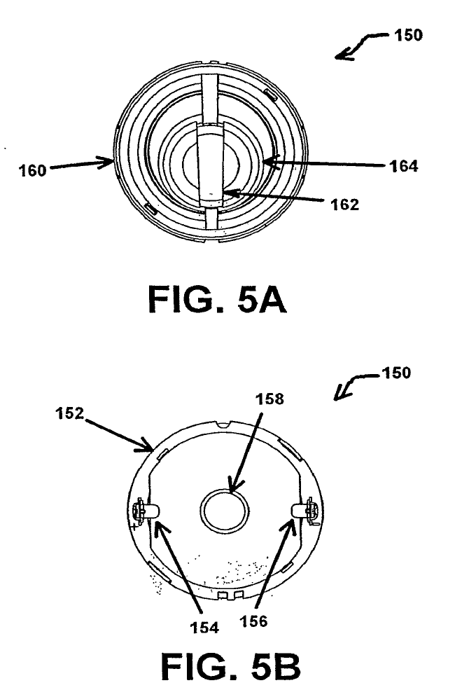

FIG. 5 shows yet another embodiment of the filter element 10. According to FIG. 5, the channels are arranged around two concentric circles 30, 32 centred on the axis 11. Of course, it is possible to further increase the number of circles in which the channels are arranged. The arrangement in FIG. 5 makes it possible to increase the surface area of the channels allowing filtering of the fluid.

According to FIG. 5, the channels are arranged in the same fashion as in FIG. 3. The remarks and descriptions for FIG. 3 are applicable to FIG. 5. FIG. 5 differs from FIG. 3 in that the channels have the same shape as the channels in FIG. 2. In particular, the peripheral wall 18 is flat and the straight cross section of the element is circular, the distance between the peripheral wall and the outside surface thus reducing on each side of the middle of the peripheral wall. The remarks and descriptions in FIG. 2 are applicable to FIG. 5.

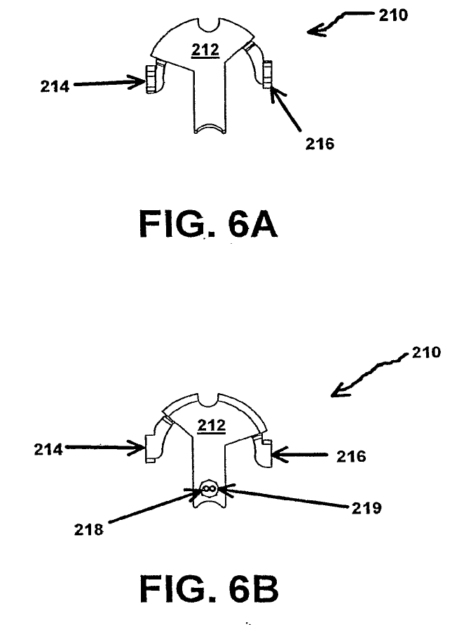

FIG. 6 shows another embodiment. According to FIG. 6, the channels comprise a side wall 20 directed towards an adjacent channel of a single circle, the side walls of two adjacent channels forming a partition 22. The side walls of two adjacent channels of a single circle form a partition 22 having a constant thickness. Moreover, the wall 18 is flat and the support can have a circular cross section. In a straight cross section, the channels 16 in FIG. 6 have an approximately triangular shape. The wall can also be concave towards the inside of the channel, as in FIG. 1. The distance “d” between the flat wall 18 and the circular outside surface therefore reduces on each side of the middle of the wall 18. The channels in FIG. 6 are comparable to the channels in FIGS. 1 and 2, except in that the channels in FIG. 6 do not have a section of partition flaring towards the outside of the support. Thus, FIG. 6 shows only the section 201 as well as the connection fillet 26. The thickness “e1” is constant over the entire height of the partition. It will also be noted that the side walls and the peripheral wall are connected by a connection fillet 24, as described previously. The support in FIG. 6 is simple to manufacture. The support can also comprise several concentric circles, the central circle being the one in FIG. 6. The channels of the other circles can be the channels in FIG. 6 or those in the other Figures.

According to an embodiment, the element in FIG. 7 corresponds to a disclaimer. In FIG. 7, an element 110 can be seen comprising three channels 116 arranged in a single circle in a support 112. The channels are heart-shaped comprising a side wall 1201 directed towards an adjacent channel, the side walls of two adjacent channels forming a partition 122 having a constant thickness. In particular, the element comprises channels 116 in a circle, these channels having a shape comprising a cusp. The peripheral wall 118 comprises the point 50. The drawback of the element in FIG. 7 is that the sharp edge of the cusp is difficult to produce and, if applicable, complicates the deposition of a separation layer. Therefore the peripheral wall according to the other Figures, which is continuous, is preferred. The term cusp is defined as a sharp edge; in particular a fillet of diameter greater than 0.15 mm at the heart shape (adjacent to the point labelled 50 in the Figure) is not considered a cusp.

This invention can comprise heart-shaped channels with a cusp, provided that the number of channels of this shape is different from three.

FIG. 8 is an illustration of a channel suitable for use in FIGS. 1 to 6, the channel being constituted by arcs of a circle and straight sections the geometrical characteristics of which are indicated below:
d1 is 0.3 to 1.4 mm, in particular 0.4 to 1 mm;
d2 is 1.5 to 2.5 mm, in particular 1.8 to 2.2 mm;
d3 is 1.5 to 4 mm, in particular 2.7 to 3.3 mm;
d4 is 0.8 to 1.5 mm, in particular 0.9 to 1.2 mm;
beta1 is 35 to 50°, in particular 40 to 45°, beta1 being the angle between the sections 201;
beta2 is 15 to 25°, in particular 20°, beta2 being the angle between the sections 202;
h1 is 1.5 to 5 mm, in particular 4 to 4.5 mm;
h2 is 4 to 9.5 mm, in particular 8.5 to 9 mm;
the ratio h1/h2 is comprised between 0.4 and 0.6, in particular 0.45 to 0.55 mm;

di denoting a diameter.

The number of these channels for an element with an outside diameter of 25 mm, is up to 30, especially 7 to 10, particularly 8 or 9. The number of these channels for an element with an outside diameter of 40 mm, is up to 75.

1. A filter element comprising
a support with an outside surface,
at least three channels in the support, the channels comprising
a wall directed towards the outside surface, the distance between the wall and the outside surface reducing on each side of the middle of the peripheral wall.

2. The element according to claim 1, excluding the element comprising channels in a circle, these channels being heart-shaped and comprising moreover a side wall directed towards an adjacent channel, the side walls of two adjacent channels forming a partition having a constant thickness.

3. The element according to claim 1 excluding the element comprising channels in a circle, these channels having a shape comprising a cusp.

4. The element according to claim 1, wherein the channels comprise moreover a side wall directed towards an adjacent channel, the side walls of two adjacent channels forming a partition having a constant thickness.

5. The element according to claim 1, wherein the channels comprise moreover a side wall directed towards an adjacent channel, the side walls of two adjacent channels forming a partition of variable thickness.

6. The element according to claim 1, wherein the channels comprise moreover a side wall directed towards an adjacent channel, the side walls of two adjacent channels forming a partition, the partition having a thickness increasing from the centre of the support towards the outside surface.

7. The element according to claim 6, wherein the partition has moreover a part with a constant thickness.

8. The element according to claim 7, wherein the part of the partition with constant thickness and a part of the partition having thickness increasing towards the outside surface are of the same height.

9. The element according to claim 7, wherein the ratio between the height of the part with constant thickness and the total height of the partition is between 1:4 and 3:4.

10. The element according to claim 7, wherein, in straight cross section, the side wall of the channels comprises at least two sections between them forming an angle of 1° to 45°, preferably 100 to 25°.

11. The element according to claim 10, wherein the peripheral wall and the side wall are connected by a connection fillet.

12. The element according to claim 11, wherein the element further comprises two side walls, the side walls being connected by a connection fillet to the peripheral wall.

13. The element according to claim 12, wherein the side walls are connected by a connection fillet.

14. The element according to claim 13, in which the connection fillet between the side walls has a diameter of 0.2 to 2 mm, preferably 0.3 to 1 mm.

15. The element according to claim 11, wherein the connection fillet between a side wall and the peripheral wall has a diameter of 1 to 4 mm, preferably 1.7 to 3 mm.

16. The element according to claim 1, wherein the element comprises between 5 and 10 channels.

17. The element according to claim 1, wherein the channels are in at least one circle.

18. The element according to claim 1, wherein the channels are in several concentric circles.

19. The element according to claim 18, wherein
the channels comprise a side wall directed towards an adjacent channel of a single circle, the side walls of two adjacent channels forming a partition, and in which the side walls of two adjacent channels of a single circle form a partition of variable thickness.

20. The element according to claim 19, wherein the partition between two channels of the centremost circle of the support has a thickness increasing towards the outside surface and the partition between two channels of the other circle(s) has a thickness reducing towards the outside surface.

21. The element according to claim 19, wherein the partition between two channels of the centremost circle of the support has a thickness increasing towards the outside surface and the partition between two channels of the other circle(s) has a thickness which reduces, and then increases towards the outside surface.

22. The element according to claim 18, wherein the element comprises at least one ring of channels intermingled with the channels of another ring.

23. The element according to claim 1, wherein the distance between the peripheral wall of the channels and the outside surface of the support reduces on each side of the middle of the peripheral wall.

24. The element according to claim 1, wherein along a straight cross section, the element has a circular shape and the peripheral wall of the channels being flat.

25. The element according to claim 1, wherein the peripheral wall is concave.

26. The element according to claim 1, wherein the element does not comprise any separation layer.

27. The element according to claim 1, wherein the element comprises a separation layer on the inside surface of the channels.

28. A filter module comprising several filter elements, the filter elements comprising
a support with an outside surface,
at least three channels in the support, the channels comprising
a wall directed towards the outside surface, the distance between the wall and the outside surface reducing on each side of the middle of the peripheral wall.

29. The filter module according to claim 28, excluding the element comprising channels in a circle, these channels being heart-shaped and comprising moreover a side wall directed towards an adjacent channel, the side walls of two adjacent channels forming a partition having a constant thickness.

30. The filter module according to claim 28, excluding the element comprising channels in a circle, these channels having a shape comprising a cusp.
